(19) United States
(12) Patent Application Publication
(10) Pub. No.: US 2011/0108790 A1
(43) Pub. Date: May 12, 2011

(54) GATE

(75) Inventors: Stephen Cromie, County Down (GB); John Gribben, County Down (GB)

(73) Assignee: EXACT ENGINEERING AND FABRICATION LTD, Newry (GB)

(21) Appl. No.: 13/003,383

(22) PCT Filed: Jul. 8, 2009
(86) PCT No.: PCT/EP2009/004926

§ 371 Date: Jan. 10, 2011

(30) Foreign Application Priority Data
Jul. 11, 2008 (GB) 0812718.5

(51) Int. Cl. E06B 11/02; E05B 65/06

(52) U.S. Cl. 256/73; 14/71.1

(57) ABSTRACT

A gate assembly comprising a gate member pivotally mounted on a frame to be rotatable about a generally horizontal pivot axis at a lower end of the gate member to be pivotable between an upright closed position and a substantially horizontal ground engaging open position, wherein said pivot axis is vertically displaceable on the frame between a lower position and an upper position, a latch member provided on one of the gate member and the frame arranged to engage a receiving recess provided on the other of the gate member and the frame when the pivot axis is in its upper position to secure the gate in its upright position, biasing means being provided for biasing said pivot axis towards its upper position and for biasing the gate member towards its closed position, actuating means being provided for urging said pivot axis of the gate member to its lowered position in response to the action of a vehicle upon said actuating means to release the latch member from the receiving recess to allow the gate member to pivot towards its open position.

This invention relates to a gate and in particular to a gate for permitting passage therethrough of a vehicle, in particular a quad bike, without requiring the rider to dismount the vehicle.

It is common to provide gates to enable access to fenced in pastures, fields and yards while preventing the escape of livestock. It is important to keep such gates closed to prevent the escape of livestock

A common way of travelling around a farm is by means of a quad bike or ATV (all terrain vehicle). Such vehicles allow a farmer to visit several grazing pastures in a short time and to travel down roads between pastures in a quick and efficient manner, using much less fuel than a tractor and providing greater maneuverability and less impact upon soft ground, due to the small size and relatively light weight of such vehicles. Due to such advantages, quad bikes have become popular with farmers in recent years.

However, a problem the use of quad bikes is that the farmer must repeatedly dismount his quad bike to open and subsequently close each gate that he must pass through. Where a number of gates have to be passed through on a regular trip, the need to open and close the gates can become tiresome and time consuming.

Attempts have been made to provide gates that automatically open to allow the passage of a quad bike or other vehicle therethrough. However, such prior art systems either suffer from excessive complexity, leading to high cost and unreliability, and/or fail to adequately prevent animals from also passing through the gate.

An example of a known gate adapted to allow the passage of a quad bike is disclosed in GB 2 433 092, which discloses a gate pivotally attached at a lower end to a frame to pivot about a horizontal axis, wherein the gate is openable upon application of an opening force against the gate, for example by riding a quad bike into the gate, to lie against the ground to permit the quad bike to ride over the gate. A restoring means, in the form of a counterweight and pulley system, biases the gate to its upright position. While this gate allows quad bikes and other vehicles to pass through the gate by effectively pushing the gate out of the way, this arrangement cannot prevent animals from also pushing the gate open and potentially escaping.

U.S. Pat. No. 3,303,613 discloses a similar gate arrangement where the gate can be pushed down to a horizontal position against a restoring force to allow a vehicle to drive over the gate. However, in this arrangement a latching mechanism is provided for retaining the gate in its upright closed position, the latching mechanism comprising a latch member 59 provided on the gate, extendable to be receivable in a receiving opening 58 provided on the gate post. The latch member 59 is releasable from the receiving opening 58 by means of a triggering mechanism comprises a vertical bar 45 pivotally mounted on a central region of the gate arranged to be struck by a vehicle and pivoted against the gate to withdraw the latch member 59 from the receiving opening on the gate post to allow the gate to open. This arrangement may result in damage to the vehicle upon impact with the gate and also damage to the gate and latch mechanism. Furthermore, the latch mechanism may be activated by an animal pressing against the gate.

According to the present invention, there is provided a gate assembly comprising a gate member pivotally mounted on a frame to be rotatable about a generally horizontal pivot axis at a lower end of the gate member to be pivotable between an upright closed position and a substantially horizontal ground engaging open position, wherein said pivot axis is vertically displaceable on the frame between a lower position and an upper position, a latch member provided on one of the gate member and the frame arranged to engage a receiving recess provided on the other of the gate member and the frame when the pivot axis is in its upper position to secure the gate in its upright position, biasing means being provided for biasing said pivot axis towards its upper position and for biasing the gate member towards its closed position, actuating means being provided for urging said pivot axis of the gate member to its lowered position in response to the action of a vehicle upon said actuating means to release the latch member from the receiving recess to allow the gate member to pivot towards its open position.

In a preferred embodiment said latch member is provided on said gate member and said receiving recess is provided on said frame, said receiving member comprising a downwardly open recess within which said latch member is receivable.

Preferably the gate member comprises a framework of elongate bars, including a transverse lower bar having a longitudinal axis aligned with said pivot axis, the ends of the lower bar of the gate member being received in respective U-shaped channels provided on the frame on either side of the gate member to pivotally support the gate member therein, said U shaped channels being generally vertically arranged whereby the ends of the lower bar of the gate member are vertically slidable within said channels between said upper and lower positions. The ends of said U-shaped channels may be closed to delimit the vertical movement of the gate member within the frame between its upper and lower positions. Preferably upper ends of the U-shaped channels are closed by respective pins extending between the sides of each U-shaped channel. Preferably the lower ends of the U-shaped channels are closed by a lower bar of the frame.

Said recess may be defined between a pair of spaced apart generally downwardly extending fingers. Each finger may be pivotally mounted on a support to be moveable between a first position wherein the finger extends substantially downwardly to retain said latch member within the receiving recess, and a second position wherein the finger extends inwardly towards the opposite finger to permit the latch member to enter the recess as the gate member moves from its open to its closed position with the pivot axis of the gate in its upper position, said finger being biased, preferably under gravity, towards its first position.

In a preferred embodiment, said actuating means comprises at least one elongate ramp member extending from the gate member in a direction substantially transverse to the gate member when the gate member is in its upright position, said at least one ramp member being engageable by the wheels of a vehicle to provide a downwards force on said gate member to move said pivot axis between its raised and lowered positions against the action of the biasing means.

Preferably said at least one ramp member is pivotally mounted on the gate member to be pivotable about a generally horizontal axis. Preferably the at least one ramp member is pivotally mounted on the gate member such that, when the pivot axis of the gate member is in its raised position and the gate member is in its upright position, a first end of the ramp member mounted on the gate member is spaced above the ground and a second distal end of the ramp member, opposite said first end, rests upon the ground such that the ramp member extends at an inclined angle to the ground. Preferably said at least one ramp member is pivotally mounted on the gate member for rotation about the pivot axis of the gate member, such that the ramp member does not interfere with the pivotal movement of the gate member. Preferably the at least one ramp member comprises attachment means at or adjacent a distal end thereof to permit the ramp member to be folded to an upright position and releasably secured to the gate member.

Preferably at least one ramp member is provided on each side of the gate member.

A pair of spaced apart ramp members may be provided on each side of the gate member, the spacing of the ramp members being substantially equal to the track of a quad bike.

Preferably said at least one ramp member comprises an open structure to deter cattle and other animals from standing thereon. Preferably said at least one ramp member comprises first and second parallel elongate members having a plurality of parallel transverse members extending therebetween.

Preferably said biasing means comprises at least one tension spring extending generally vertically between a side region of the frame and a side region of the gate member. A tension spring may be provided on each side of the gate member, preferably extending between an middle or upper region of a respective side of the frame and a respective side of the gate member, preferably adjacent a lower end of the gate member, preferably spaced from the pivot axis of the gate member.

Preferably the frame is mounted between a pair of spaced parallel gate posts, said frame being pivotally mounted on one of said gate posts to pivotal about a generally vertical axis between open and closed positions. Preferably said gate member is mounted within an opening in the frame adjacent said one of the gate posts to which the frame is pivotally attached.

Alternatively said frame member may be fixed in place to form a barrier, for example to comprise a section of fencing.

Preferably said opening receiving said gate member extends across a portion of the frame, said opening being of sufficient width to permit the passage of a quad bike therethrough. Preferably said frame extends around said opening for greater strength. Alternatively said frame may extend around the bottom and side of said opening, an upper side of said opening being clear to provide unlimited headroom.

According to a further aspect of the present invention there is provided a closure comprising a gate member pivotally mounted on support to be rotatable about a generally horizontal pivot axis at a lower end of the gate member to be pivotable between an upright closed position wherein the gate substantially closes an opening in the support and a substantially horizontal open position wherein an object can pass through said opening, a latch member provided on one of the gate member and the support for retaining the gate member in its closed position, biasing means being provided for biasing the gate member to its closed position, actuating means being provided for releasing the latch member to allow the gate member to move to its open position in response to the action of an object said actuating means to allow said object to pass through said opening.

An embodiment of the present invention will now be described by way of example only, with reference to the accompanying drawings, in which:—

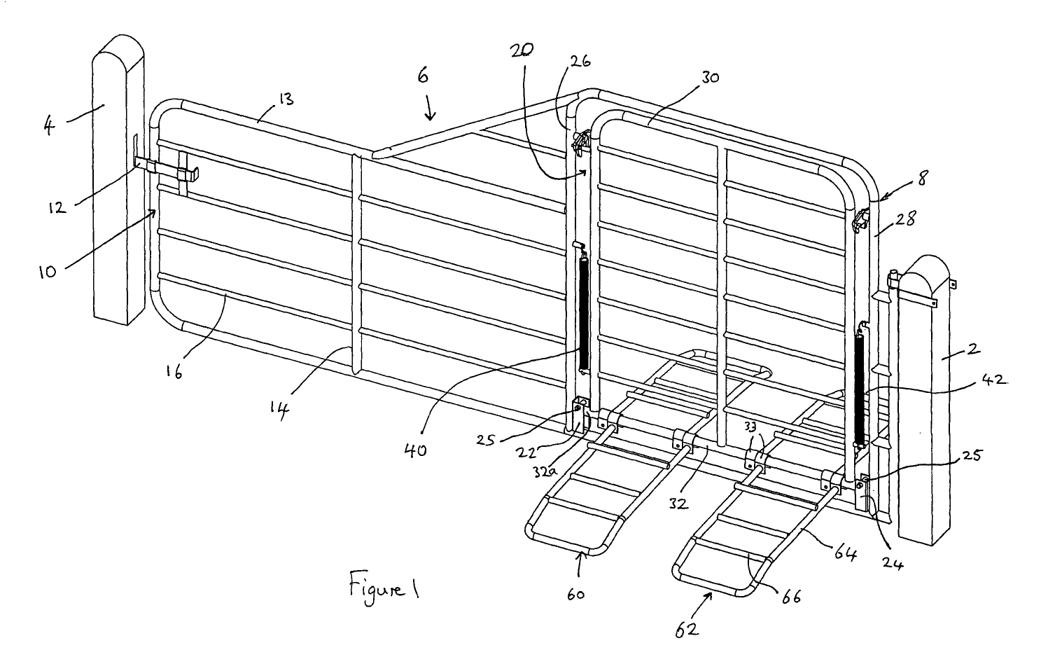

FIG. 1 is a perspective view of a gate assembly according to an embodiment of the present invention in a closed configuration;

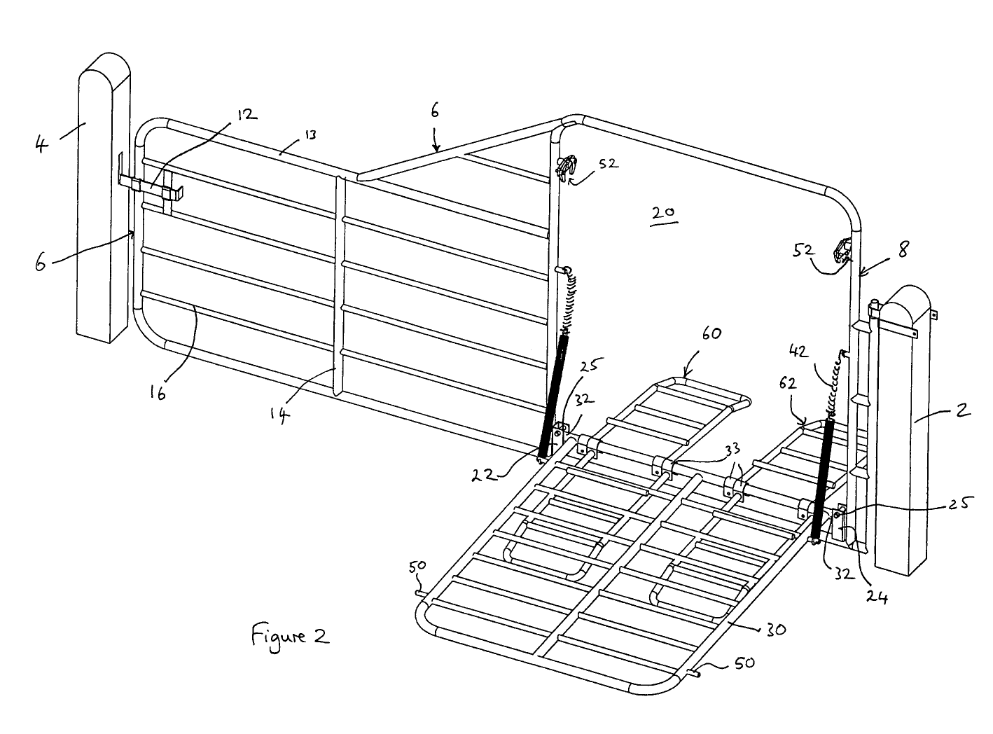

FIG. 2 is a perspective view of the gate of FIG. 1 in an open configuration; and

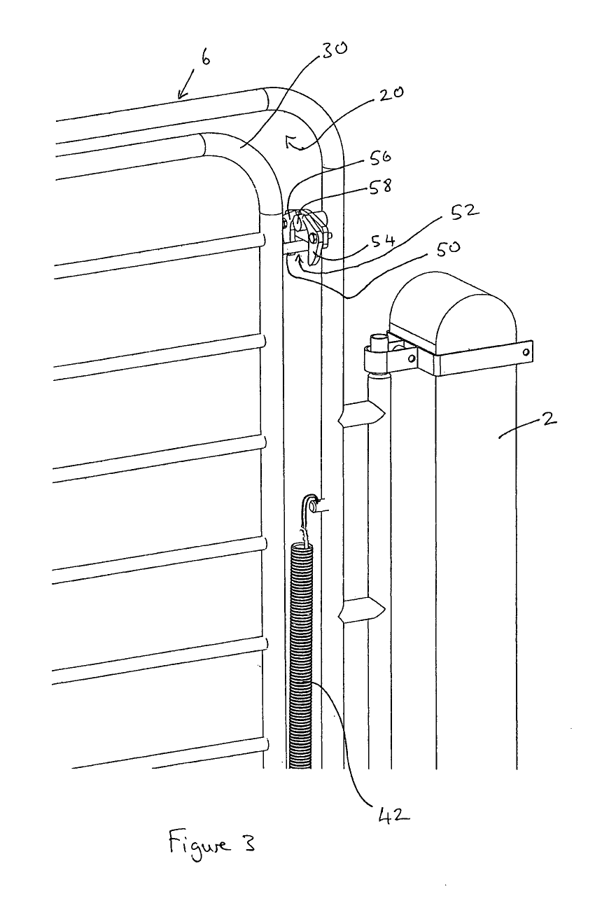

FIG. 3 is a detailed perspective view of the latch mechanism of the gate assembly of FIG. 1.

As illustrated in the drawings, a gate assembly according to an embodiment of the present invention comprises a pair of laterally spaced apart gate posts 2,4 and a gate frame 6 mounted therebetween, a first side 8 of the gate frame 6 being pivotally attached to a first gate post 4 to enable the gate frame 6 to open about a vertical pivot axis and a second side 10 of the gate frame 6 being provided with a sliding bar 12 arranged to secure the frame 6 to the opposite post 4 on the second side 10 of the frame 6. The gate frame 6 comprises a tubular outer loop 12 and a plurality of vertical bars 14 and horizontal bars 16 extending therebetween.

An opening 20 is defined in a region of the gate frame 6 adjacent the first side 8 of the frame of sufficient size to allow a quad bike and rider to pass therethrough. A gate member 30 is pivotally mounted to a lower region of the frame 6 to be pivotable about a horizontal pivot axis between an upright closed position (as shown in FIG. 1), closing said opening, and a substantially horizontal ground engaging open positions (as shown in FIG. 2) on either side of the frame 6.

The ends 32a of the lower bar 32 of the gate member extend outwardly from the sides of the gate member 30 to be received within vertically arranged inwardly facing U-shaped channels 22,24 provided on the frame 6 at lower sides of the opening 20, such that the gate member 20 is pivotable about said lower bar 32, the lower bar 32 defining the pivot axis of the gate member 30. The ends of the lower bar 32 of the gate member 30 are arranged to be vertically slidable within the U-shaped channels 22,24 to be vertically moveable between upper and lower positions therein. Upper ends of the U-shaped channels 22,24 are closed by pins 25 extending through the upper ends of the channels 22,24 to retain the gate member 30 therein.

The gate member 30 is biased to it upright position by means of springs 40,42 mounted between lower side regions of the gate member 30 and side regions 26,28 of the frame surrounding the opening. The springs 40,42 also serve to bias the ends of the lower bar 32 to their upper position within the U-shaped channels 22,24.

The gate member 30 is secured in its upright position within the opening 20 by means of a latch mechanism comprises a pair of latch members 50 extending transversely from respective side regions of the gate member 30 to be receivable in a downwardly facing receiving recess 52 defined between downwardly extending spaced latch finger members 54,56. As best seen in FIG. 3, each latch finger 54,56 comprises a substantially L-shaped member pivotable between an operative position, wherein the inner end of the L-shaped member engages a stop 58 to retain the latch member 50 within the receiving recess 52 define therebetween, and a raised position, to allow the respective latch member 50 to pass into the respective receiving recess 52 defined between the latch fingers 54,56. The pivotal mounting of each latch finger 54,56 allows the latch fingers to pivot inwardly to allow the respective latch members 50 to move past the latch fingers 54,56 into the respective receiving recess 52 as the gate member 30 moves from its horizontal open position to its upright closed position.

A pair of ramp members 60,62 are mounted on each side of the gate member, pivotally mounted on the lower bar 32 of the gate member 30 to extend substantially transversely therefrom. The spacing of each pair of ramp members 60,62 is arranged to correspond to the spacing between the wheels on each side of a quad bike. Each ramp is mounted on the lower bar 32 of the gate member 30 by means of spaced U shaped hooks 33 adapted to fit over the lower bar 32. A pin or bolt may be inserted through an outer end of each hook 33 to retain the respective ramp member 60,62 onto the lower bar 32 of the gate member 30.

Each ramp member 60,62 may be provided with a releasable fastening means adjacent an outer end thereof to enable the ramp member 60,62 to be folded to a generally upright position and to be secured to the gate member 30 to allow the gate frame 6 to be opened.

The ramp members 60,62 are arranged such that a quad bike, approaching the gate member from either side, runs its front wheels up the ramp members on that side, depressing the ramp members 60,62 and moving the ends of the lower bar 32 of the gate member 30 downwardly within the U-shaped channels 22,24, against the action of the springs 40,42, to their lower position, moving the latch members 50 out of the respective receiving recesses 52 to release the gate member 30.

Further movement of the quad bike towards the gate member 30 causes the quad bike to push the gate member 30 out of the opening 20 towards its open position to allow the quad bike to pass through the opening 20 and ride over the lowered gate member 30. Once the quad bike has passed over the gate member, the restoring force provided by the springs 40,42 causes the gate member 30 to pivot to its upright closed position and the ends of the lower bar 32 to be pulled up the U-shaped channels 22,24 to their upper positions.

As the gate member 30 reaches its upright closed position the latch members 50 strike the outer surface of one of the respective latch fingers 54,56, which pivots inwardly and allow the respective latch member 50 to enter the respective receiving recess 52 to retain the gate member 30 in its upright closed position.

Each ramp member 60,62 comprises a tubular outer frame 64 having a plurality of parallel transverse bars 66 extending at spaced locations to provide support for the wheels of the quad bike. The open structure of the ramp members 60,62 prevents the ramp members 60,62 from being depressed by livestock. Therefore the latch mechanism cannot be accidentally released and the gate member 30 cannot be accidentally opened by livestock, providing greater security while enabling a quad bike to readily traverse the gate without requiring the rider to dismount from the quad bike. Each ramp member 60,62 comprises an outer portion 64 inclined downwardly such that a main portion 66 of each ramp member 60,62 is substantial horizontal when the outer end of the ramp rests on the ground. This enables the force applied onto the lower bar 32 by the weight of a quad bike on the ramp to exert a downwardly force on the lower bar 32 of the ramp member in a substantially vertical direction.

The opening 20 within which the gate member 30 is mounted may be provided on either side of the gate frame 6, or centrally therein, and may extend across a part of all of the width of the gate frame. The upper bar of the gate frame extending above the gate member may be omitted to provide greater headroom, if desired.

While the gate assembly has been described for use with a quad bike, to allow a quad bike to pass through an opening in a farm gate, the gate member could alternatively be provided in a section of fencing or in any other barrier means through which it is desired to provide vehicular access. For example, the gate frame 6 could be fixedly mounted between the gate posts 2,4.

The opening and gate member may be dimensioned to allow passage of a desired vehicle, for example a tractor. The principle of the present invention may also be applied to the operation of any closure member for closing an opening, where it is desired to automatically release a latch mechanism of the closure member as an object moves through the opening.

The invention is not limited to the embodiments described herein but can be amended or modified without departing from the scope of the present invention.

1. A gate assembly comprising a gate member pivotally mounted on a frame to be rotatable about a generally horizontal pivot axis at a lower end of the gate member to be pivotable between an upright closed position and a substantially horizontal ground engaging open position, wherein said pivot axis is vertically displaceable on the frame between a lower position and an upper position, a latch member provided on one of the gate member and the frame arranged to engage a receiving recess provided on the other of the gate member and the frame when the pivot axis is in its upper position to secure the gate in its upright position, biasing means being provided for biasing said pivot axis towards its upper position and for biasing the gate member towards its closed position, actuating means being provided for urging said pivot axis of the gate member to its lowered position in response to the action of a vehicle upon said actuating means to release the latch member from the receiving recess to allow the gate member to pivot towards its open position.

2. A gate assembly as claimed in claim 1, wherein said latch member is provided on said gate member and said receiving recess is provided on said frame, said receiving member comprising a downwardly open recess within which said latch member is receivable.

3. A gate assembly as claimed in claim 1, wherein the gate member comprises a framework of elongate bars, including a transverse lower bar having a longitudinal axis aligned with said pivot axis, ends of the lower bar of the gate member being received in respective U-shaped channels provided on the frame on either side of the gate member to pivotally support the gate member therein, said U shaped channels being generally vertically arranged whereby the ends of the lower bar of the gate member are vertically slidable within said channels between said upper and lower positions.

4. A gate assembly as claimed in claim 3, wherein ends of said U-shaped channels are closed to delimit the vertical movement of the gate member within the frame between its upper and lower positions.

5. A gate assembly as claimed in claim 4, wherein upper ends of the U-shaped channels are closed by respective pins extending between sides of each U-shaped channel.

6. A gate assembly as claimed in claim 3, wherein lower ends of the U-shaped channels are closed by a lower bar of the frame.

7. A gate assembly as claimed in claim 1, wherein said recess is defined between a pair of spaced apart generally downwardly extending fingers.

8. A gate assembly as claimed in claim 7, wherein each finger is pivotally mounted on a support to be moveable between a first position wherein the finger extends substantially downwardly to retain said latch member within the receiving recess, and a second position wherein the finger extends inwardly towards the opposite finger to permit the latch member to enter the recess as the gate member moves from its open to its closed position with the pivot axis of the gate in its upper position, said finger being biased, preferably under gravity, towards its first position.

9. A gate assembly as claimed in claim 1, wherein said actuating means comprises at least one elongate ramp member extending from the gate member in a direction substantially transverse to the gate member when the gate member is in its upright position, said at least one ramp member being engageable by the wheels of a vehicle to provide a downwards force on said gate member to move said pivot axis between its raised and lowered positions against the action of the biasing means.

10. A gate assembly as claimed in claim 9, wherein said at least one ramp member is pivotally mounted on the gate member to be pivotable about a generally horizontal axis.

11. A gate assembly as claimed in claim 10, wherein the at least one ramp member is pivotally mounted on the gate member such that, when the pivot axis of the gate member is in its raised position and the gate member is in its upright position, a first end of the ramp member mounted on the gate member is spaced above the ground and a second distal end of the ramp member, opposite said first end, rests upon the ground such that at least a portion of the ramp member extends at an inclined angle to the ground.

12. A gate assembly as claimed in claim 9, wherein said at least one ramp member is pivotally mounted on the gate member for rotation about the pivot axis of the gate member, such that the ramp member does not interfere with the pivotal movement of the gate member.

13. A gate assembly as claimed in claim 9, wherein the at least one ramp member comprises attachment means at or adjacent a distal end thereof to permit the ramp member to be folded to an upright position and releasably secured to the gate member.

14. A gate assembly as claimed in claim 9, wherein at least one ramp member is provided on each side of the gate member.

15. A gate assembly as claimed in claim 9, wherein a pair of spaced apart ramp members are provided on each side of the gate member, the spacing of the ramp members being substantially equal to the track of a quad bike.

16. A gate assembly as claimed in claim 9, wherein said at least one ramp member comprises an open structure to deter cattle and other animals from standing thereon.

17. A gate assembly as claimed in claim 16, wherein said at least one ramp member comprises first and second parallel elongate members having a plurality of parallel transverse members extending therebetween.

18. A gate assembly as claimed in claim 9, wherein said at least one ramp member is mounted on the gate member by one or more downwardly facing hook shaped member adapted to engage a horizontal bar of the gate member.

19. A gate assembly as claimed in claim 1, wherein said biasing means comprises at least one tension spring extending generally vertically between a side region of the frame and a side region of the gate member.

20. A gate assembly as claimed on claim 19, wherein a tension spring is provided on each side of the gate member.

21. A gate assembly as claimed in claim 20, wherein each tension spring extends between a middle or upper region of a respective side of the frame and a respective side of the gate member, preferably adjacent a lower end of the gate member, preferably spaced from the pivot axis of the gate member.

22. A gate assembly as claimed in claim 1, wherein the frame is mounted between a pair of spaced parallel gate posts, said frame being pivotally mounted on one of said gate posts to pivotal about a generally vertical axis between open and closed positions.

23. A gate assembly as claimed in claim 22, wherein said gate member is mounted within an opening in the frame adjacent said one of the gate posts to which the frame is pivotally attached.

24. A gate assembly as claimed in claim 22, wherein said frame member is fixed in place to form a barrier, for example to comprise a section of fencing.

25. A gate assembly as claimed in claim 22, wherein said opening receiving said gate member extends across a portion of the frame, said opening being of sufficient width to permit the passage of a quad bike therethrough.

26. A gate assembly as claimed in claim 22, wherein said frame extends around said opening for greater strength.

27. A gate assembly as claimed in claim 22, wherein said frame extends around the bottom and sides of said opening, an upper side of said opening being clear to provide unlimited headroom.

28. A closure comprising a gate member pivotally mounted on support to be rotatable about a generally horizontal pivot axis at a lower end of the gate member to be pivotable between an upright closed position wherein the gate substantially closes an opening in the support and a substantially horizontal open position wherein an object can pass through said opening, a latch member provided on one of the gate member and the support for retaining the gate member in its closed position, biasing means being provided for biasing the gate member to its closed position, actuating means being provided for releasing the latch member to allow the gate member to move to its open position in response to the action of an object said actuating means to allow said object to pass through said opening.
